(19) United States
(12) Patent Application Publication
(10) Pub. No.: US 2010/0113101 A1
(43) Pub. Date: May 6, 2010

(54) MOBILE TERMINAL

(75) Inventor: Tosaku TANADA, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/537,446

(22) Filed: Aug. 7, 2009

(30) Foreign Application Priority Data
Oct. 31, 2008 (JP) P2008-281937
Oct. 31, 2008 (JP) P2008-281938

(51) Int. Cl. H04M 1/00

(52) U.S. Cl. 455/566; 345/173

(57) ABSTRACT

A mobile terminal has a housing, a touch-type input unit configured to accept an input of a first instruction by detecting a touch to a touch face provided on a surface of the housing, a detecting unit configured to detect an operation to a movable unit, and a control unit configured to negate the first instruction during detecting the operation by the detecting unit even if the touch-type input unit accepts the input.

### BACKGROUND OF THE INVENTION

1. Field of the Invention

The present invention relates to a mobile terminal, and more particularly, to a mobile terminal for suitably preventing false triggering of a touch-type input unit.

2. Description of the Related Art

A variety of input devices are used for various types of mobile terminals such as cellular phones. For example, mobile terminals equipped with a so-called jog dial have been known with capability of achieving a faster and simpler input operation than an operation using operation keys by pressing the keys (see, for example, Japanese Unexamined Patent Application Publication No. 2007-41641) The jog dial is, in general, rotationally operable in both normal and opposite directions. Various types of information such as characters, images, and the like which has been stored in advance, are scroll-displayed on a display screen in accordance with the rotational direction of the jog dial.

Further, for mobile terminals like cellular phones in particular, a variety of types of housings, i.e., a slide-type, a flip-type, a swivel-type, and a reversible-type, are adopted.

For example, a mobile terminal having an opening/closing structure may form a close state so as to be carried in a compact state. In addition, when the mobile terminal is in use, the mobile terminal forms an open state, in which a keypad such as operation keys is exposed widely, allowing an input operation to be performed easily.

Each of the types of the cellular phones as described above has own advantages as well as drawbacks, and various techniques to eliminate such drawbacks have been disclosed (for example, see Japanese Unexamined Patent Application Publication No. 2007-215218)

When operating a movable-type input device that requires a rotational or sliding operation such as a jog dial, a user uses his/her fingers to perform a rotational or sliding operation in accordance with a movable range of the input device to perform an input operation.

Along with the current trend of downsizing mobile terminals, a movable-type input device such as a jog dial has also been downsized. As a result, when performing a rotational operation of the jog dial with a finger, the finger may go out of the jog dial, mostly resulting in unintentional touches to a surface area of a housing or the other input devices of the mobile terminal.

On the other hand, a mobile terminal including touch sensors with which a user can perform an input operation by touching the sensors with his/her finger has become widely known in recent years. In striving for further improvement in easiness in use, a mobile terminal including both the jog dial and the touch sensors as units for performing an input operation has become known.

Here, if the jog dial and the touch sensors are disposed adjacent to each other, there may be a case where the finger of the user operating the jog dial unintentionally touches the touch sensors as described above. Therefore, when operating the jog dial, chances are high that the mobile terminal causes false triggering due to unintentional touches to the touch sensors.

Disposal of the touch sensors at positions where no touch to the touch sensors occurs when operating the jog dial may be considered. However, with the current trend of downsizing the mobile terminals, actually, the arrangement of input units such as operation keys, a jog dial, and touch sensors, i.e., positioning relative to one another, is highly restrictive.

On the other hand, in a mobile terminal having an opening/closing structure, when a shift movement between an open state and a close state is caused, a sliding or rotational movement is to be performed while the housing of the mobile terminal is held in one or both hands of the user.

In the mobile terminal having touch sensors as described above, there may be a case where the finger of the user, which performs a shift movement between the open state and the close state, unintentionally touches touch sensors. Therefore, during a shift movement between an open state and a close state, there has been a problem that the false triggering occurs very frequently due to unintentional touches to touch sensors. Further, with the current trend of downsizing mobile terminals, devices such as touch sensors, operation keys, a display, etc. are compact-sized together and unintentional touches to touch sensors may occur more frequently.

### SUMMARY OF THE INVENTION

Accordingly, the present invention has been made to solve the above-described problems and it is an object of the present invention to provide a mobile terminal capable of preventing the false triggering of an operation caused by unintentional touches to a touch-type input unit.

To solve the problems described above, a mobile terminal according to the present invention has a housing; a touch-type input unit configured to accept an input of a first instruction by detecting a touch to a touch face formed on a surface of the housing; a movable unit; a detecting unit configured to detect an operation to the movable unit; and a control unit configured to negate the first instruction during detecting the operation by the detecting unit even if the touch-type input unit accepts the input.

It may be desired that the movable unit is a movable-type input unit configured to accept an input of a second instruction on the basis of the operation, the movable-type input unit being provided on the surface of the housing.

It may be desired that when the initiation of the operation of the movable-type input unit is detected, the control unit negates the first instruction by causing the touch-type input unit to be in an off state in which no input is accepted.

It may be desired that when the initiation of the operation of the movable-type input unit is detected, the control unit negates the first instruction by discarding the detection of the input accepted by the touch-type input unit.

It may be desired that the housing is the movable unit performing a shift movement between a first state and a second state different from the first state, the detecting unit detects the shift movement between the first state and the second state.

It may be desired that when the initiation of the shift movement of the housing is detected, the control unit negates the first instruction by causing the touch-type input unit to be in an off state in which no input is accepted.

It may be desired that when the completion of the shift movement of the housing is detected, the control unit negates the first instruction by discarding the detection of the input accepted by the touch-type input unit.

In another aspect of the present invention, there is also provided a mobile terminal including a housing; a touch-type input unit configured to accept an input of a first instruction by detecting a touch to a touch face provided on a surface of the housing; a movable-type input unit configured to accept an input of a second instruction, the movable-type input unit being provided on the surface of the housing; and a control unit configured to negate the first instruction during detecting the input of the movable-type input unit even if the touch-type input unit accepts the input.

In another aspect of the present invention, there is further provided a mobile terminal including a housing configured to performe a shift movement between a first state and a second state different from the first state; a touch-type input unit configured to accept an input of an instruction by detecting a touch to a touch face provided on a surface of the housing; a detecting unit configured to detect the shift movement of the housing between the first state and the second state; and a control unit configured to negate the first instruction during detecting the shift movement of the housing even if the touch-type input unit accepts the input.

The mobile terminal according to the present invention is capable of preventing the false triggering of an operation caused by unintentional touches to a touch-type input unit.

### BRIEF DESCRIPTION OF THE DRAWINGS

FIGS. 1A and 1B show an external configuration of a slide-type cellular phone according to a first embodiment of the present invention;

FIG. 2 shows an internal configuration of the cellular phone according to the first embodiment;

FIG. 3 shows an explanatory view illustrating an example of an operation of a jog dial according to the first embodiment;

FIG. 4 is a flowchart explaining an input process at a time of operating a jog dial, executed by a control unit of the cellular phone according to the first embodiment;

FIG. 5 is a flowchart explaining another input process at a time of operating a jog dial, executed by a control unit of the cellular phone according to the first embodiment;

FIGS. 6A and 6B show an external configuration of a slide-type cellular phone according to a second embodiment of the present invention;

FIG. 7 shows an internal configuration of the cellular phone according to the second embodiment;

FIGS. 8A, 8B and 8C show an explanatory view illustrating an example of a shift movement of the cellular phone from a close state to an open state according to the second embodiment;

FIG. 9 is a flowchart explaining an input process at a time of a shift movement of the housings is performed, executed by a control unit of the cellular phone according to the second embodiment; and

FIG. 10 is a flowchart explaining another input process at a time of performing the shift movement of the housings, executed by a control unit of the cellular phone according to the second embodiment.

### DESCRIPTION OF THE PREFERRED EMBODIMENTS

### First Embodiment

A mobile terminal according to the first embodiment of the present invention will be described below, with reference to the appended drawings.

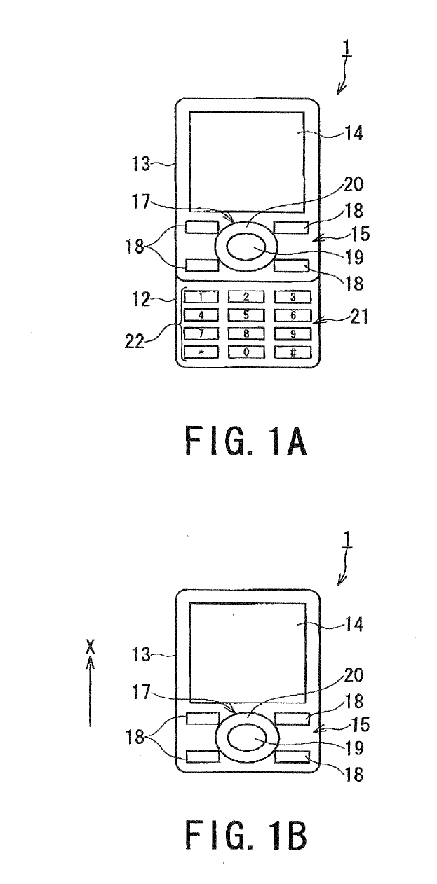

FIG. 1A and FIG. 1B are diagrams showing configurations of the outer appearance of a slide-type cellular phone 1, an example of the mobile terminals according to the present invention. FIG. 1A shows a configuration of the outer appearance of the cellular phone 1 viewed from a front side thereof, when the cellular phone 1 is extended so that a second operation section 21 is exposed (open state). FIG. 1B shows a configuration of the outer appearance of the cellular phone 1 viewed from the front side thereof, when the cellular phone 1 is contracted so that the main surface of a lower housing 12 and the back face of an upper housing 13 are folded together (close state).

In the cellular phone 1 as shown in FIGS. 1A and 1B, a display 14 on the main surface of the upper housing 13 is normally exposed. In order that the cellular phone 1 shifts from a close state in which the upper housing 13 is superposed on the lower housing 12 as shown in FIG. 1B to an open state as shown in FIG. 1A, the upper housing 13 is caused to slide in a direction of an arrow X relative to the lower housing 12, whereby the second operation section 21 on the lower housing 12 appears.

Almost the entire area of the main surface of the upper housing 13 is occupied by the display 14. The display 14 may display, in addition to the condition of air reception and the remaining battery level, the contents of e-mails, simplified websites, and the like. The display 14 includes, for example, an LCD, an organic EL display, or an inorganic EL display.

In the area below the display 14, there is a first operation section 15 with which restricted operations are performed. The first operation section 15 is provided with an input device (input unit) including a jog dial 17 and touch sensors 18.

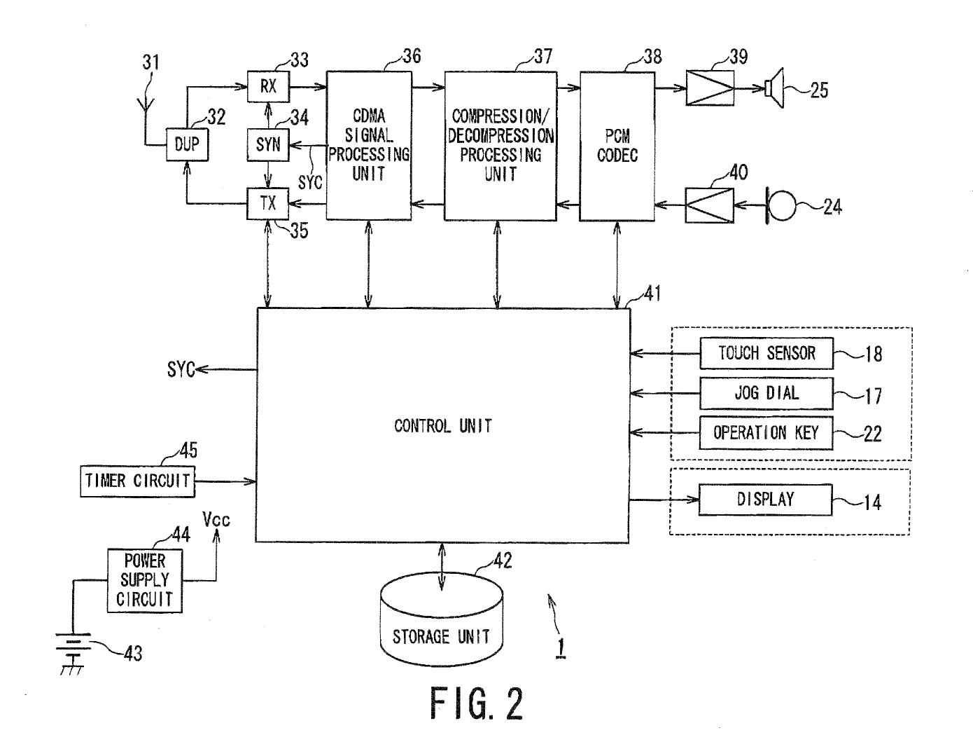

The jog dial 17 includes a push button 19 with which an input can be performed by pressing and a rotatable ring 20 that is configured to rotate and provided circularly around the push button 19. The jog dial 17 functions, together with a control unit (a control unit 41 of FIG. 2), as a movable-type input unit which accepts an input of a second instruction by detecting initiation and completion of the motion of the rotatable ring 20. The jog dial 17 is a disk-type jog dial, which rotates around an axis orthogonal to the surface of the upper housing 13. Further, the cellular phone 1 outputs rotational signals in accordance with the rotational direction of the rotatable ring 20 and executes the predetermined processes on the basis of the change patterns of the rotational signals.

A predetermined number (e.g., four) of touch sensors 18 are disposed around the jog dial 17. The touch sensors 18 function as a touch-type input unit which accepts an input of a first instruction by detecting a touch to each touch faces. A variety of systems such as a capacitance system, a resistive system, an acoustic pulse system, an ultrasound system, a surface elastic wave system, an infrared light-interception system, and an electromagnetic induction system may be applied to the touch sensors 18.

As shown in FIG. 1A, on the main surface of the lower housing 12, a second operation section 21 with which input operations are performed by, for example, pressing is disposed. The second operation section 21 is hidden behind the back of the upper housing 13 in a close state. The second operation section 21 is provided with an input unit which includes operation keys 22. With the operation keys 22, it is possible to input numbers from “0” to “9,” Japanese “kana” characters from the first row for “a” to the final row for “wa”, and alphabets from “A” to “Z.”

Incidentally, a variety of input units provided to the first operation section 15 and the second operation section 21 are mere an example, and the keys to which another functions are allocated may further be provided to the first and second operation sections 15 and 21.

A microphone which is not shown (microphone 24 shown in FIG. 2) and a receiver (receiver 25 shown in FIG. 2) are provided at predetermined positions of the lower housing 12 or the upper housing 13, to achieve a communication function. The microphone collects the speech of the user when the user talks on the phone, and then converts the speech into electric signals. The receiver converts the electric signals into an audible speech. Further, a battery pack (not shown) is mounted on the lower housing 12 at its back side.

FIG. 2 shows an internal configuration of the cellular phone according to the first embodiment. A radio signal transmitted from the base station is received by the antenna 31, passes through an antenna diplexer (DUP) 32 passes, and it input to a receiver (RX) 33. The receiver 33 may perform mixing of the received radio signal with a local oscillation signal output from a frequency synthesizer (SYN) 34 to down-convert the received radio signal into an intermediate frequency signal. Then, the receiver 33 generates a reception baseband signal by performing a quadrature (quadrature direction) on the down-converted intermediate frequency signal. The frequency of the local oscillation signal generated from the frequency synthesizer 34 is indicated by a control signal SYN output the control unit 41.

The reception baseband signal generated by the receiver 33 is input to a CDMA signal processing unit 36. The CDMA signal processing unit 36 is provided with a RAKE receiver (not shown). In the RAKE receiver, a plurality of paths included in the reception baseband signal are de-spread with respective spread codes (i e., spread codes equivalent to those of spread reception signals). Then, after the phase in the despread signals of the respective paths in adjusted, the despread signals of the respective paths are coherent Rake combined by the RAKE receiver. A data train obtained through the RAKE combining is subjected to de-interleaving, channel decoding (error correction decoding), and binary data determination. With this operation, reception packet data having a predetermined transfer format can be obtained. The reception packet data is input to a compression/decompression processing unit 37.

The compression/decompression processing unit 37 is composed of a DSP (Digital Signal Processor). The compression/decompression processing unit 37 separates the reception packet data output from the CDMA signal processing unit 36 to respective media by a multiplexer/demultiplexer (not shown), and subjects the reception packet data of the separated media to a decoding process. For example, in a call mode, speech data included in the reception packet data and corresponding to spoken voice is decoded by a speech codec. If video data is including in the reception packet data, such as in case of a video phone mode, the video data is decoded by video codec. For example, if the reception packet data is download content, the download content is decompressed (expanded) and output to the control unit 41.

A digital speech signal obtained by decoding is supplied to a PCM codec 38. The PCM codec 38 PCM-decodes the digital signal output from the compression/decompression processing unit 37, and outputs an analog speech signal obtained by the PCM decoding to a receiving amplifier 39. The analog speech signal is amplified by the receiving amplifier 39 and output by the receiver 25.

A digital video signal obtained through decoding performed by a video codec of the compression/decompression processing unit 37 is input to the control unit 41. The control unit 41 causes the display 14 to display a video image based on the digital video signal output from the compression/decompression processing unit 37 through a not shown video RAM (for example, VRAM and the like). The control unit 41 causes the display 14 to display via the RAM.

If the reception data is an e-mail message, the compression/decompression processing unit 37 supplies the e-mail massage to the control unit 41. The control unit 41 causes a storage unit 42 to store the e-mail message supplied from the compression/decompression processing unit 37. Then in response to the user's operation of the input unit, the control unit 41 reads the e-mail message stored in the storage unit 42 and causes the display 14 to display the read e-mail message.

On the other hand, in the call mode, a speaker's (user's) speech signal (analog speech signal) input to the microphone 24 is amplified to a proper level by a transmitting amplifier 40 and PCM-coding by the PCM codec 38. A digital speech signal obtained by the PCM coding is input to the compression/decompression processing unit 37. An e-mail message, which is text data generated by the control unit 41, is also input to the compression/decompression processing unit 37.

The compression/decompression processing unit 37 may compression-code the digital speech signal from the PCM codec 38 in a format corresponding to a predetermine transmission data rate. Thus, speech data is generated. Also, the compression/decompression processing unit 37 compression-codes the digital video signal from the control unit 41 so as to generate video data. Then, the compression/decompression processing unit 37 causes the multiplexer/demultiplexer to multiplex the speech data and the video data into transmission packet data in accordance with a predetermined transmission format. The compression/decompression processing unit 37 packetizes the data multiplexed in the multiplexer/demultiplexer.

The compression/decompression processing unit 37 outputs the transmission packet data after the packetization to the CDMA signal processing unit 36. When an e-mail message is output from the control unit 41, the compression/decompression processing unit 37 similarly cause the multiplexer/demultiplexer to multiplex the e-mail message into transmission packet data

The CDMA signal processing unit 36 uses a spread code assigned to a transmission channel to perform spread spectrum processing on the transmission packet data output from the compression/decompression processing unit 37, and outputs an output signal generated by the spread spectrum processing to a transmitter (TX) 35. The transmitter 35 modulates the signal after the spread spectrum processing by using a digital modulation method such as a QPSK (Quadrature Phase Shift Keying) method. The transmitter 35 synthesizes the transmission signal after the digital modulation with the local oscillation signal generated from the frequency synthesizer 34 to up-convert the transmission signal into the radio signal. Then, the transmitter 35 high-frequency-amplifies the radio signal generated by the up-conversion so as to obtain the transmission power level indicated by the control unit 41. The high-frequency-amplified radio signal is supplied to the antenna 31 through the antenna diplexer 32 and transmitted to the base station from the antenna 31.

Further, the cellular phone 1 is provided with a timer circuit 45 indicating an exact current time and a predetermined time.

The control unit 41 includes, for example, a CPU (Central Processing Unit), a ROM (Read Only Memory), and a RAM (Random Access Memory). The CPU executes various kinds of processing in accordance with programs stored in the ROM or various application programs loaded from the storage unit 42 into the RAM. The CPU generates various control signals and supplies the generated control signals to the components in the cellular phone 1 to control the overall operation of the cellular phone 1. The RAM appropriately stores data necessary for the CPU to execute the various processing. Further, the control unit 41 also includes a video RAM that temporarily stores information about moving images displayed on the display 14.

The storage unit 42 is, for example, a flash memory device, which is an electronically erasable and programmable read only memory, or an HDD (Hard Disc Drive). The storage unit 42 stores the various application programs executed by the CPU in the control unit 41 or various data groups. A power supply circuit 44 generates a predetermined operating power supply voltage Vcc based on a power of a battery 43 and supplies the voltage to each circuit portion.

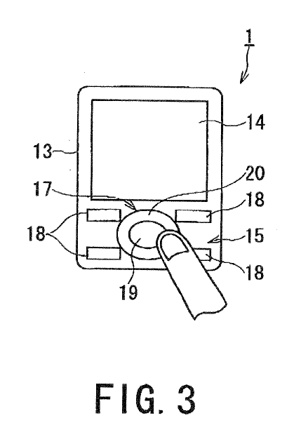

FIG. 3 is an explanatory view illustrating an example of an operation of the jog dial 17 according to the present embodiment. As shown in FIG. 3, in order that a user rotates the rotatable ring 20 of the jog dial 17, the user presses his/her finger against the rotatable ring 20, and then rotates the rotatable ring 20 in a clock-wise or counter-clockwise direction about the push button 19. When doing this, it is highly likely that the finger of the user goes out of the jog dial 17, resulting in high likelihood that the finger of the user touches the touch sensors 18 disposed around the jog dial 17.

The cellular phone 1 according to the present embodiment is configured to suitably prevent the occurrence of false triggering of the touch sensors 18 caused by unintentional touches to the touch sensors 18 when operating the jog dial 17 disposed in the first operation section 15.

In the input process at a time of operating the jog dial as will be described below, the cellular phone 1 negates an input of an instruction accepted by the touch sensors 18 by keeping the power source of the touch sensors 18 in an off state from the time when the jog dial 17 detects the initiation of the rotational operation to the time when it detects the completion of the rotational operation, thereby preventing the occurrence of the false triggering caused by unintentional touches to the touch sensors 18. Hereinafter, details of the input process at a time of operating the jog dial will be described.

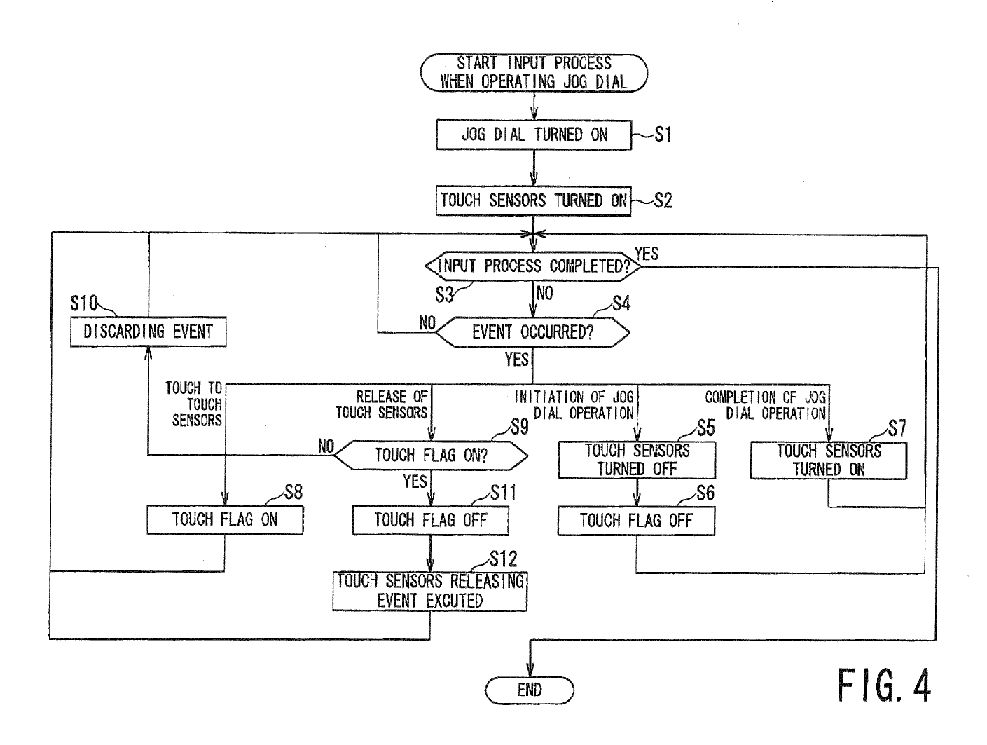

FIG. 4 shows a flowchart explaining an input process at a time of operating the jog dial, executed by a control unit 41 of the cellular phone 1 according to the present embodiment. The input process at a time of operating the jog dial may be initiated when an execution of the input process is initiated after the cellular phone 1 accepts an instruction of turning on the power source by a predetermined input operation, or when each operation-lock of the first operation section 15 and the second operation section 21 is released (this may be applied to the case of releasing the lock of the operation section in part, the case of releasing the jog dial 17, or the case of releasing the lock of the touch sensors 18. The same can be mentioned below) Further, as to the operation to the touch sensors, merely touching the touch sensors is not recognized as an input, but when the touch sensors are touched for a time longer than a predetermined period of time (“long press”) or when the touch sensors detect the completion of the touch before the predetermined period of time lapses (“short press”), the touch sensors then can detect the instruction.

In step S1, the control unit 41 turns the jog dial 17 ON The jog dial 17 detects the rotational operation of the rotatable ring 20, whereby it becomes in a state where it can accept an input operation. In step S2, the control unit 41 turns the touch sensors 18 ON. The touch sensors 18 detect the initiation of a touch (hereinafter referred to as “touch”) and the completion of a touch (hereinafter referred to as “release”), whereby the touch sensors 18 become in a state where the touch sensors 18 can accept an input operation.

In step S3, the control unit 41 determines whether the input process is completed or not. The input process is completed after the cellular phone 1 accepts the instruction of turning off the power source by a predetermined input operation, or when the operation lock of the first operation section 15 or the second operation section 21 is set. When the control unit 41 determines that the input process is completed, it ends the input process at a time of operating the jog dial.

On the other hand, when the control unit 41 determines that the input process has not been completed, it determines whether the occurrence of predetermined events is detected in step S4. The predetermined events include the initiation and completion events of the rotational operation of the rotatable ring 20 of the jog dial 17 and the touch and release events of the touch sensors 18. Incidentally, in this embodiment, the explanation as to the case where the other event processes (e.g., pressing of the operation keys 22 and an incoming call) occur is omitted. When the control unit 41 determines that predetermined events are not detected, it then returns to an input-process completion-determination step S3.

When the control unit 41 detects the occurrence of the initiation event of the rotational operation of the jog dial 17 in an event-occurrence determination-step S4, it turns the touch sensors 18 OFF, thereby causing the touch sensors 18 to be in an off state in which no input is accepted. Here, since the touch sensors 18 are in an off state, the control unit 41 does not detect the touch and release of the touch sensors 18. With this arrangement, in the cellular phone 1, even when unintentional touches to the touch sensors 18 (touch and release) occur after initiation of the rotational operation of the jog dial 17, the false triggering of the processes allocated to the touch sensors 18 may be prevented.

In step S6, the control unit 41 sets a touch flag OFF. This touch flag is normally set ON in a flag ON step S8, after the touch event of the touch sensors 18 is detected in the event-occurrence determination-step S4. Incidentally, when the touch flag is set OFF, the control unit 41 maintains the off state as it is in step S6. The control unit 41 then returns to the input-process completion-determination step S3 and repeats the subsequent processes.

Next, when the control unit 41 detects the completion event of the rotational operation of the jog dial 17 in the event-occurrence determination-step S4, in step S7, it turns the touch sensors 18 ON, thereby causing the touch sensors 18 to be in an on state in which an input to the touch sensors 18 is accepted. In this process, the touch sensors 18, which have been in an off state in the touch sensor OFF step 35 in accordance with the detection of the initiation of the rotational operation of the jog dial 17, are recovered so as to be in an on state in which an input operation can be accepted The control unit 41 then returns to the input-process completion-determination step S3 and repeats the subsequent processes. Incidentally, the completion event of the rotational operation of the jog dial 17 is, for example, an event which occurs when no rotational operation of the jog dial 17 is detected for a predetermined period of time after the initiation Of the rotational operation of the jog dial 17.

On the other hand, when the control unit 41 detects the touch event of the touch sensors 18 (The touch event of the touch sensors 18 include the case where the touch event of one of the touch sensors 18 and the case where the touch event of more than one of the touch sensors 18. The same can be mentioned below.) in the event-occurrence determination-step S4, it sets the touch flag ON in step S8. The control unit 41 then returns to the input-process completion-determination step S3, and repeats the subsequent processes.

Further, when the control unit 41 detects the occurrence of the release event of the touch sensors 18 in the event-occurrence determination-step S4, it determines whether the touch flag is set ON in step S9. When the control unit 41 determines that the touch flag is set OFF, it discards the release event in step S10 because the corresponding touch event does not occur. The case where a release is still detected even when the touch flag is set OFF includes the case where the touch sensors 18 are touched before initiation of the rotational operation of the jog dial 17 or during the rotational operation of the jog dial 17 (touch sensors 18 are in an off state), and then the touch sensors 18 are released after the rotational operation of the jog dial 17 is completed while the touches to the touch sensors 18 are maintained (touch sensors 18 are in an on state).

When the control unit 41 determines that the touch flag is set ON, it sets the touch flag OFF in step S11. Further, in step S12, the control unit 41 executes a predetermined process in accordance with the detection of the occurrence of the release event of the touch sensors 18. That is, the control unit 41 executes a predetermined process on the basis of the input of the instruction accepted by the touch sensors 18. Incidentally, the control unit 41 is configured to execute predetermined processes allocated to the touch sensors 18 upon the release corresponding to the detected touch is detected. The touch sensors 18 may be able to accept different kinds of input operations depending on how long the touch sensors 18 are touched (duration of touch).

The operation of the touch sensors 18 are not limited to the above described operations, but the touch sensors 18 may also execute the predetermined processes upon detecting a touch. The control unit 41 returns to the input-process completion-determination step S3, and repeats the subsequent processes.

In this input process at a time of operating the jog dial, the touch sensors 18 are kept turned off during the time from the initiation to the completion of the rotational operation of the jog dial 17. With this arrangement, the touch and release events of the touch sensors 18 do not occur during the time from the initiation to the completion of the rotational operation of the jog dial 17, and therefore it is possible to suitably prevent the occurrence of the false triggering of the touch sensors accompanying the rotational operation of the jog dial 17.

Further, in the case where the events occur in an order of: (1) touch event of the touch sensors 18; (2) rotational operation initiation event of the jog dial 17; (3) rotational operation completion event of the jog dial 17; and (4) release event of the touch sensors 18, the touch flag is set OFF in the flag OFF step S6 after the occurrence of (2) rotational operation initiation event of the jog dial 17. Thus, even when unintentional touches to the touch sensors 18 occur before the rotational operation of the jog dial 17, it is determined that the touch flag is set OFF in the flag ON determination step S9 after the occurrence of (4) release event of the touch sensors 18, and the detection of the release is discarded, which prevents the occurrence of the false triggering of the touch sensors.

Further, since the touch sensors 18 are kept in a power-off state when rotating the jog dial 17, it is possible to achieve power saving.

Next, another input process at a time of operating a jog dial, executed by the cellular phone 1 according to the present embodiment will be described.

In another input process at a time of operating a jog dial as will be described below, in the case where the touch or release event of the touch sensors 18 occurs from the time when the jog dial 17 detects initiation of the rotational operation to the time when the jog dial 17 detects the completion of the rotational operation, the cellular phone 1 negates the input of the instruction accepted by the touch sensors 18 by discarding the detection of the input (the occurrence of the event) With this arrangement, the cellular phone 1 may be able to prevent the occurrence of the false triggering of the touch sensors 18 due to unintentional touches to the touch sensors 18. Details of another input process at a time of operating a jog dial will be described below.

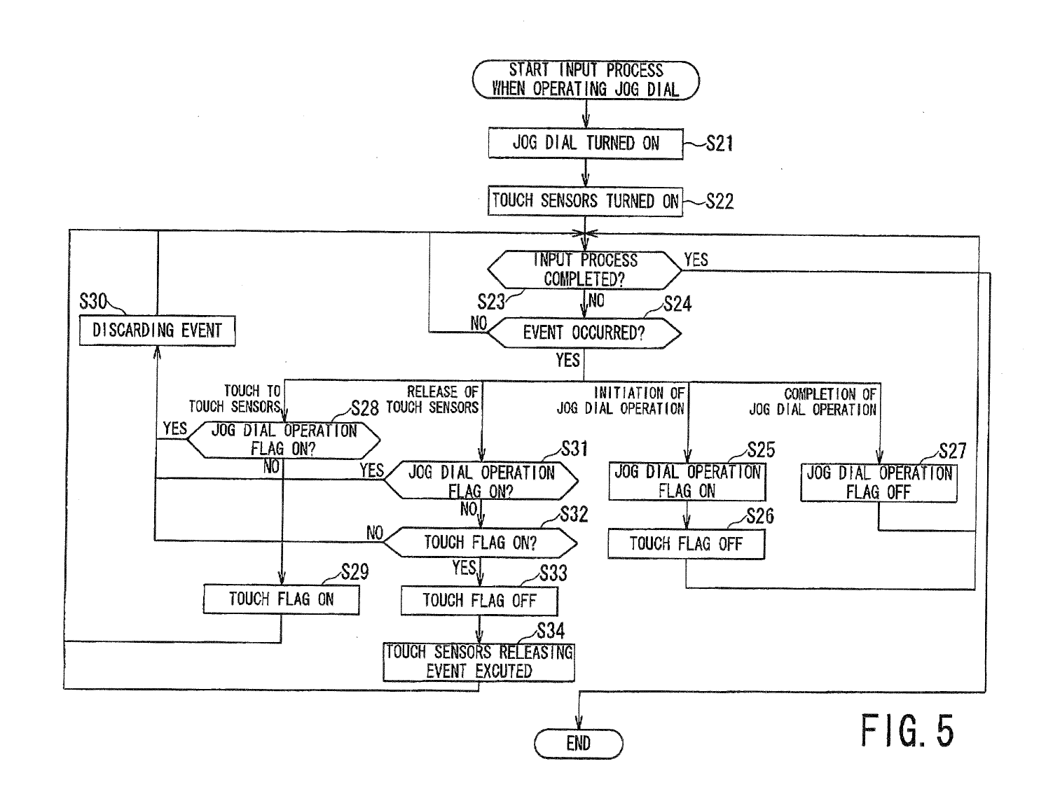

FIG. 5 shows a flowchart explaining another input process at a time of operating a jog dial, executed by the control unit 41 of the cellular phone 1 in accordance with the present embodiment. The another input process at a time of operating a jog dial is initiated after the cellular phone 1 accepts an instruction of turning on the power source by a predetermined input operation or when the operation lock of the first operation section 15 or the second operation section 21 is released, whereby the execution of the input process is initiated.

The processes in a jog-dial turned-on step S21 to an event-occurrence determination step S24 are generally similar to those of the jog-dial turned-on step S1 to the event-occurrence determination step S4 in the input process at a time of operating the jog dial in FIG. 4, and therefore the explanation thereof is omitted herein.

When the control unit 41 detects the occurrence of the initiation event of the rotational operation of the jog dial 17 in the event-occurrence determination step S24, it sets a jog dial operation flag ON in step S25. Further, in step S26, the control unit 41 sets the touch flag OFF. Incidentally, when the touch flag is set OFF, the control unit 41 maintains the off state as it is in step S26. The control unit 41 returns to an input-process completion-determination step S32, and repeats the subsequent processes.

Next, when the control unit 41 detects the completion event of the rotational operation of the jog dial 17 in the event-occurrence determination step S24, it sets the jog dial operation flag OFF in step S27. The control unit 41 then returns to the input-process completion-determination step S23 and repeats the subsequent processes.

On the other hand, when the control unit 41 detects a touch to the touch sensors 18 in the event-occurrence determination step S24, it determines whether a jog dial operation flag is set ON in step S28. When the control unit 41 determines that the jog dial operation flag is set OFF, it sets the touch flag ON in step S29. The control unit 41 then returns to the input-process completion-determination step S23 and repeats the subsequent processes.

On the other hand, when the control unit 41 determines that the jog dial operation flag is set ON, it discards the touch event in step S30 because the touches to the touch sensors 18 occur during the rotational operation of the jog dial 17, and therefore the touch event occurred may be recognized as unintentional touches.

Further, when the control unit 41 detects the occurrence of the release event of the touch sensors 18 in the event-occurrence determination step S24, it determines whether the jog dial operation flag is set ON in step S31 When the control unit 41 determines that the jog dial operation flag is set ON, it discards the release event in step S30 because the release of the touch sensors 18 occurs during the rotational operation of the jog dial 17, and therefore the release may be recognized as the one corresponding to unintentional touches.

On the other hand, when the control unit 41 determines that the jog dial operation flag is set OFF, it determines whether the touch flag is set ON in step S32. When the control unit 41 determines that the touch flag is set OFF, it discards the release event in step S30, because the corresponding touch event does not occur.

The case where a release is still detected even when the touch flag is set OFF includes the case where the touch sensors 18 are touched before initiation of the rotational operation of the jog dial 17 or during the rotational operation of the jog dial 17 while the touches to the touch sensors 18 are maintained (touch flag is set OFF), and then the touch sensors 18 are released after the rotational operation of the jog dial 17 is completed.

When the control unit 41 determines that the touch flag is set ON in step S32, it sets the touch flag OFF in step S33. Further, in step S34, the control unit 41 executes a predetermined process in accordance with the detection of the release of the touch sensors 18. That is, the control unit 41 executes a predetermined process on the basis of the input of the instruction accepted by the touch sensors 18. The control unit 41 then returns to the input-process completion-determination step S23 and repeats the subsequent processes.

In the another input process at a time of operating the jog dial, the touch and release events of the touch sensors 18 occurred during the time from the initiation to the completion of the rotational operation of the jog dial 17, are discarded. Accordingly, a predetermined process in accordance with the detection of the release of the touch sensors 18 is not executed, whereby it is possible to suitably prevent the occurrence of the false triggering of the touch sensors accompanying the rotational operation of the jog dial 17.

Further, in the cases where the events occur in an order of: (1) touch event of the touch sensors 18; (2) rotational operation initiation event of the jog dial 17; (3) release event of the touch sensors 18; and (4) rotational operation completion event of the jog dial 17, and an order of: (1) touch event of the touch sensors 18; (2) rotational operation initiation event of the jog dial 17; (3) rotational operation completion event of the jog dial 17; and (4) release event of the touch sensors 18, the control unit 41 sets the touch flag OFF in a flag OFF step S26 after the occurrence of (2) rotational operation initiation event of the jog dial 17. That is, the control unit 41 discards the detection of the touch event upon the initiation of the rotational operation of the jog dial 17. Thus, even when unintentional touches to the touch sensors 18 occur before the rotational operation of the jog dial 17, it is determined that the touch flag is set OFF in the flag ON determination step S32 after the occurrence of (4) release event of the touch sensors 18, and the detection of the release is discarded, which prevents the occurrence of the false triggering of the touch sensors.

According to the cellular phone 1, the touch sensors 18 are kept in a power-off state or the input of the instruction accompanying the touch or release event of the touch sensors 18 that is detected is negated from the time when the jog dial 17 detects the initiation of the rotational operation to the time when the jog dial 17 detects the completion of the rotational operation, whereby the false triggering of the touch sensors 18 caused by unintentional touches to the touch sensors 18 may be suitably prevented.

Incidentally, although an example in which a disk-type jog dial is applied to the cellular phone 1 as a movable-type input unit is described according to the present embodiment, the other movable-type input units which may require a certain size of movable area for the finger of the user, which operates the movable input units, may also be applied to the present invention. The movable-type input units that are applicable to the present invention include: rotative-type input units such as a side jog which is disposed on the side surface of the lower housing 12 or the upper housing 13, the part of which being protruded from the side surface and being operable by rotation and a center jog with a cylindrical-shaped dial which is disposed on the upper housing 13 in a laid-down manner, the part of which being protruded from the main surface of the upper housing 13 and being rotatable about an axis parallel to the main surface; and slide-type input units such as a slide switch that switches on and off by sliding on a flat surface and a pointing device.

Further, the layout of the movable-type input unit such as the jog dial 17 and the touch-type input unit such as the touch sensors 18 are not limited to that disclosed in FIG. 1. Yet further, the locations at which the jog dial 17 and the touch sensors 18 are disposed are not limited to the same surface of the same housing, but the jog dial 17 and the touch sensors 18 may be disposed in different surfaces. For example, the jog dial 17 may be disposed on the main surface of the upper housing 13, whereas the touch sensors 18 may be disposed on the side surface.

Further, although an application to the slide-type cellular phone 1 in which the upper housing 13 slides relative to the lower housing 12 so as to be superposed on the lower housing 12 has been described, the cellular phone 1 may include the following types: a so-called folding-type in which upper housing and lower housing are hinged together; a swivel-type in which housings are rotatable about an rotation axis perpendicular to the rotation axis of a hinge; a reversible-type in which housings are capable of 360-degree rotation about a rotation axis of a hinge; and a so-called straight-type in which a single housing is used.

### Second Embodiment

The second embodiment of the mobile terminal according to the present invention will be described hereunder with reference to the appended drawings. The mobile terminal in this second embodiment is different from that of the first embodiment in that it includes an arrow key and an enter key instead of a jog dial. Incidentally, configurations and elements corresponding to those of the first embodiment are added with the same reference numerals, and the descriptions thereof are omitted.

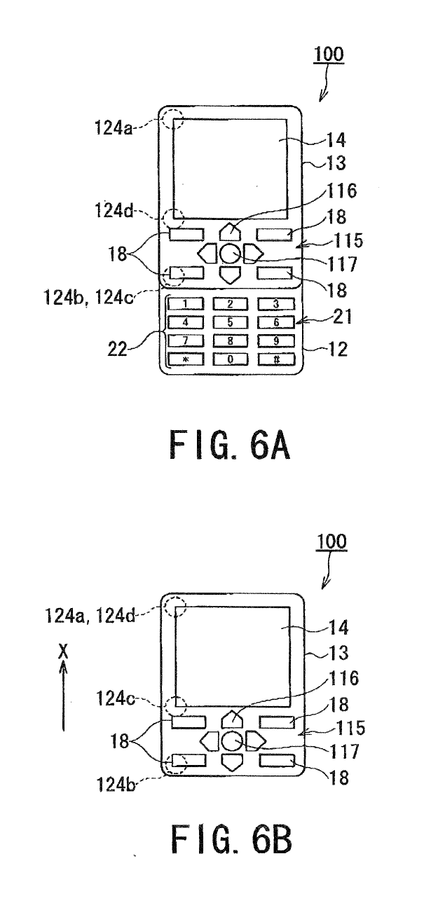

FIGS. 6A and 6B show external configurations of a slide-type cellular phone 100, which is an example of mobile terminals according to the present invention. FIG. 6A shows an external configuration of the cellular phone 100 viewed from a front side thereof when it is extended so that a second operation section 21 is exposed (open state). FIG. 6B shows an external configuration of the cellular phone 100 viewed from the front side thereof, when it is contracted so that the main surface of a lower housing 12 and the back face of an upper housing 13 are folded together (close state).

In the cellular phone 100 as shown in FIGS. 6A and 6B, the display 14 on the main surface of the upper housing 13 is normally exposed. In order that the cellular phone 100 shifts from the close state in which the upper housing 13 is superposed on the lower housing 12 as shown in FIG. 6B to the open state as shown in FIG. 6A, the upper housing 13 is caused to slide in a direction of an arrow X relative to the lower housing 12, whereby the second operation section 21 on the lower housing 12 appears. This open state and the close state respectively correspond to a “first state” and a “second state” or vice versa.

On the main surface of the upper housing 13, the display 14 is provided. In an area below the display 14, there is provided a first operation section 115 that performs restricted operations. The first operation section 115 is provided with input units including an arrow key 116 having a four directions of up, down, left, and right key (four-direction key), an enter key 117, and touch sensors 18.

The arrow key 116 is operated in the up, down, left, and right directions, thereby being able to move a cursor, etc. displayed on the display 14 in the up, down, left, and right directions. Further, the enter key 117 accepts confirmation instructions of a variety of processes. A predetermined number (e.g., four) of touch sensors 18 are disposed around the arrow key 116. The touch sensors 18 function as a touch-type input unit which accepts an input of a first instruction by detecting a touch to each touch faces.

As shown in FIG. 6A, on the main surface of the lower housing 12, the second operation section 21 with which input operations are performed by, for example, depressing the same, is disposed. Incidentally, a variety of input units of the first operation section 115 and the second operation section 21 are mere an example, and keys to which other functions are allocated may further be provided to the each operation section.

The cellular phone 100 is provided with magnetic sensors 124a, 124b, 124c, and 124d (magnetic sensors 124) which detect whether the housings 12 and 13 are in the open state or in the close state. The magnetic sensors 124a and 124b are disposed in the predetermined positions on the upper housing 13. The magnetic sensors 124c and 124d are disposed in the predetermined positions on the lower housing 12. The magnetic sensors 124 serve as a detecting unit for detecting the shift movement performed between the open state and the close state of the housings 12 and 13.

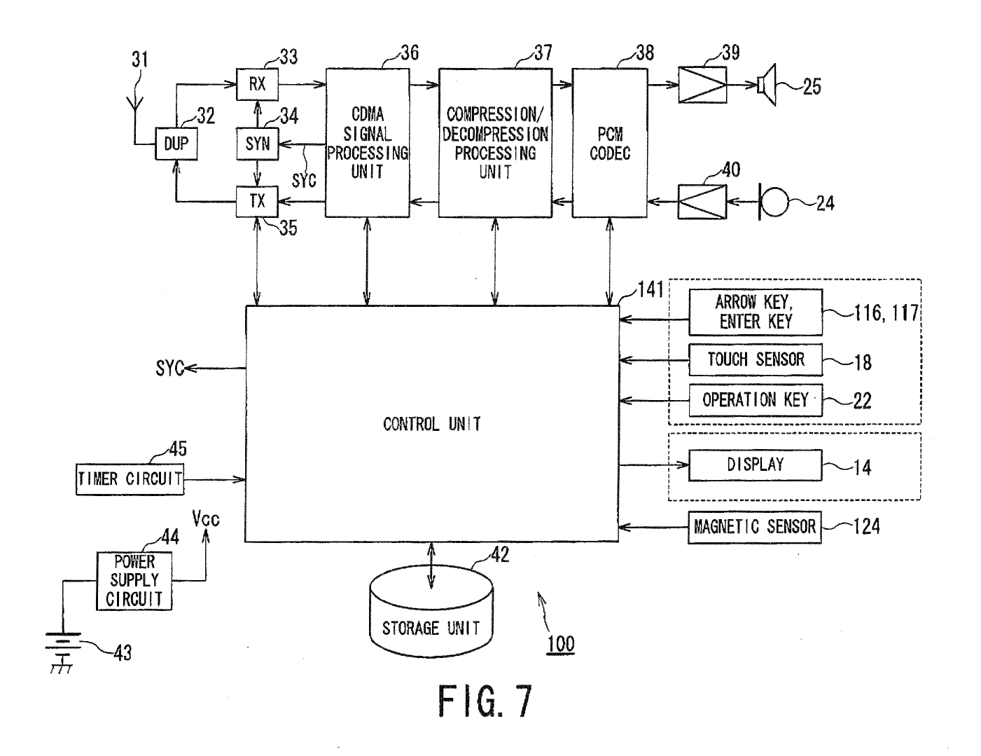

FIG. 7 shows an internal configuration of the cellular phone 100 according to the present embodiment.

Incidentally, configurations and elements corresponding to those of the first embodiment are added with the same reference numerals, and the descriptions thereof are omitted.

The control unit 141 includes a CPU, ROM, and RAM. The CPU executes a variety of processes in accordance with a variety of application programs loaded in the RAM from programs stored in the ROM or a memory section 42, while generating various kinds of control signals, and then supplying the control signals to each section of the cellular phone 100, thereby performing an overall control on the cellular phone 100. The RAM appropriately stores data, etc. required for executing a variety of processes by the CPU. The control unit 141 serves as a control unit in this embodiment.

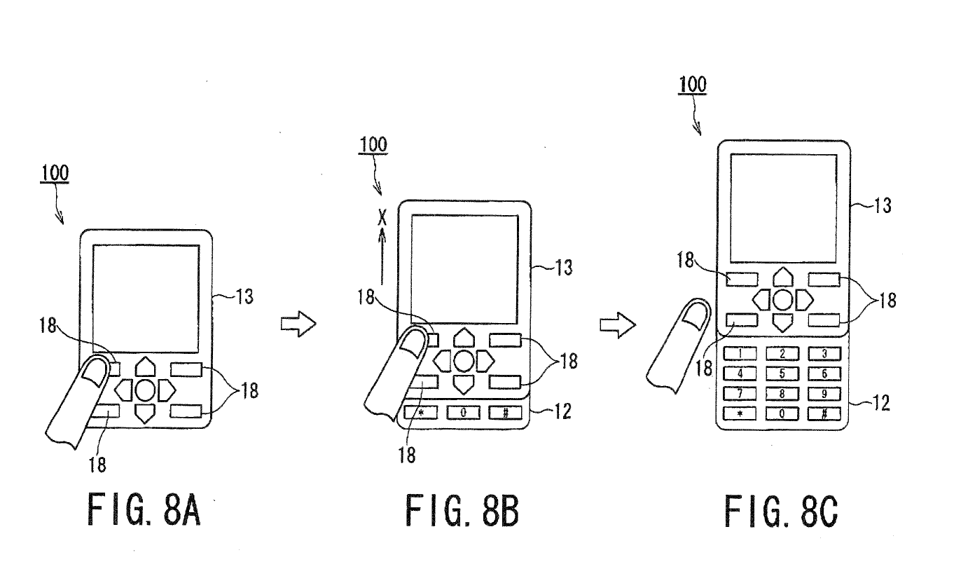

FIGS. 8A, 8B, and 8C are diagrams explaining a shift movement of the cellular phone 100 from the close state to the open state according to the present embodiment. Incidentally, the explanation of a shift movement of the cellular phone 100 from the open state to the close state is omitted since it is an operation performed reversely to the shift movement from the close state to the open state shown in FIGS. 8A, 8B, and 8C.

When the lower housing 12 and the upper housing 13 are caused to slide relative to each other to thereby shift from the close state to the open state, it is highly likely that a user presses his/her finger against somewhere on the upper housing 13 (in the figure, an area at which touch sensors 18 are disposed) as shown in FIG. 8A. Thereafter, as shown in FIG. 8B, a user causes the upper housing 13 to slide in the direction of an arrow X, to thereby change the state of the cellular phone 100 to the open state shown in FIG. 8C. When doing this, it is highly likely that the finger of the user that causes the upper housing 13 to slide touches to the touch sensors 18.

The cellular phone 100 according to the present embodiment is configured to suitably prevent the occurrence of the false triggering of the touch sensors caused by unintentional touches to the touch sensors 18 by a user, during a shift movement between the open state and the close state of the housings 12 and 13.

In the input process at a time of performing the shift movement of the housings that will be described below, the cellular phone 100 keeps the power source of the touch sensors 18 in an off state from the time when the cellular phone 100 detects the initiation of the shift movement of the housings 12 and 13 to the time when the cellular phone 100 detects the completion of the shift movement of the housings 12 and 13, thereby preventing the occurrence of the false triggering caused by unintentional touches to the touch sensors 18.

Here, the cellular phone 100 detects, by using the magnetic sensors 124c and 124d of the lower housing 12 as shown in FIG. 6, the detection levels of the magnetic sensors 124a and 124b that are provided in the upper housing 13, to thereby detect the initiation and the completion of the shift movement, as well as the current status of the housings 12 and 13 (open state and close state).

When the shift movement from the close state to the open state according to the present embodiment is initiated, the detection signals from the magnetic sensor 124a detected by the magnetic sensor 124d shift below a predetermined level. On the other hand, when the shift movement from the close state to the open state is completed, the detection signals from the magnetic sensor 124b detected by the magnetic sensor 124c shift above the predetermined level. When the shift movement from the open state to the close state is initiated, the detection signals from the magnetic sensor 124b detected by the magnetic sensor 124c shift below the predetermined level. On the other hand, when the shift movement from the open state to the close state is completed, the detection signals from the magnetic sensor 124a detected by the magnetic sensor 124d shift above the predetermined level. Incidentally, the layout of the magnetic sensors 124a to 124d is not limited to the above. Likewise, the number of the magnetic sensors is not limited to the above. In addition, it may be possible to determine whether the magnetic sensors are in the state of FIG. 8A or that of FIG. 8C, in consideration of the mechanism.

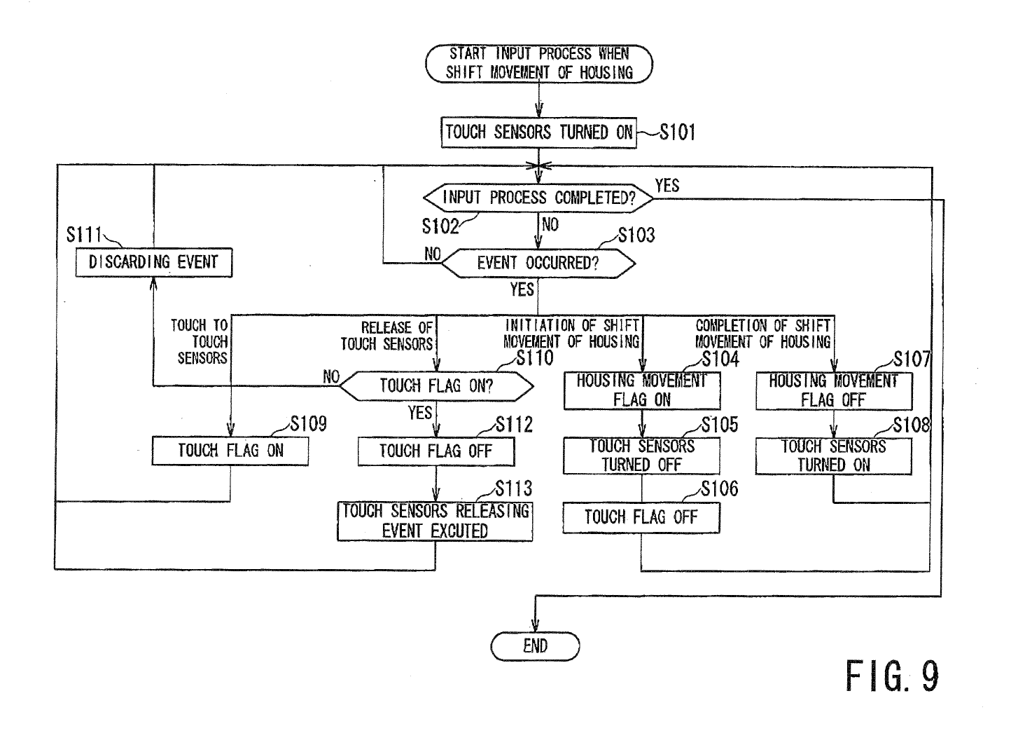

FIG. 9 is a flowchart explaining an input process at a time of performing the shift movement of the housings, executed by the control unit 141 of the cellular phone 100, according to the present embodiment. The input process at a time of performing the shift movement of the housings may be performed, when an execution of the input process is initiated after the cellular phone 100 accepts an instruction of turning on the power source by a predetermined input operation, or when each operation lock of the first operation section 115 and the second operation section 21 is released (this may be applied to the case of releasing the lock of the operation section in part or the case of releasing the lock of the touch sensors 18. The same can be said below). Further, as to the operation of the touch sensors 18, merely touching the touch sensors 18 is not recognized as an input, but when the touch sensors 18 is touched for longer than a predetermined period of time (“long press”) or when the touch sensors 18 detect the completion of the touch before the predetermined period of time lapses (“short press”), the touch sensors 18 then become operable.

In step S101, the control unit 141 turns the power source of the touch sensors 18 ON. The touch sensors 18 detect the initiation of the touch (hereinafter referred to as “touch”) and the completion of the touch (hereinafter referred to as “release”), whereby it becomes in a state where it can accept an input operation.

In step S102, the control unit 141 determines whether the input process is completed or not. The input process is completed when the cellular phone 100 has accepted an instruction of turning off the power source by a predetermined input operation, or when the operation lock of the first operation section 115 or the second operation section 21 has been set. When the control unit 141 determines that the input process is completed, it ends the input process at a time of performing the shift movement of the housings.

On the other hand, when the control unit 141 determines that the input process has not been completed, it determines whether the occurrence of the predetermined events is detected in step S103. The predetermined events includes the initiation and completion events of the shift movement of the housings 12 and 13 and the touch and release events of the touch sensors 18. Incidentally, in this embodiment, the explanation as to the case where the other event processes (e.g., pressing of the operation keys 122 and an incoming call) occur is omitted. When the control unit 141 determines that the predetermined events are not detected, it returns to the input-process completion-determination step S102.

When the control unit 141 detects the occurrence of the initiation event of the shift movement of the housings 12 and 13 in the event-occurrence determination-step S103, it sets a housing movement flag ON in step S104. In step S105, the control unit 141 turns the touch sensors 18 OFF, thereby causing the touch sensors 18 to be in an off state in which no input to the touch sensors 18 is accepted. Here, since the touch sensors 18 are kept in an off state, the control unit 141 does not detect the touch and release of the touch sensors 18. With this arrangement, the cellular phone 100 does not cause false triggering of the processes allocated to the touch sensors 18, even when unintentional touches to the touch sensors 18 occur during the shift movement of the housings 12 and 13.

In step S106, the control unit 141 sets the touch flag OFF. This touch flag is normally set ON in a flag ON step S109 after the touch event of the touch sensors 18 is detected in the event-occurrence determination-step S103. The control unit 141 sets this touch flag OFF in accordance with the initiation of the shift movement of the housings 12 and 13, thereby discarding the touch event of the touch sensors 1 that has already occurred and been detected. Incidentally, when the touch flag has already been set OFF, the control unit 141 maintains the off state as it is in step S106. The control unit 141 returns to the input-process completion-determination step S102, and repeats the subsequent processes.

Next, when the control unit 141 detects the completion event of the shift movement of the housings 12 and 13 in the event-occurrence determination step S103, it sets the housing movement flag OFF in step S107. In step S108, the control unit 141 turns the touch sensors 18 ON, thereby causing the touch sensors 18 to be in an on state in which the input to the touch sensors 18 is accepted. In this process, the touch sensors 18, which have been in an off state in the touch sensor OFF step S105 in accordance with the detection of the initiation of the shift movement of the housings 12 and 13, are recovered so as to be in an on state in which an input operation can be accepted. The control unit 141 then returns to the input-process completion-determination step S102 and repeats the subsequent processes.

On the other hand, when the control unit 141 detects the touch event of the touch sensors 18 in the event-occurrence determination step S103, it sets the touch flag ON in step S109. The control unit 141 then returns to the input-process completion-determination step S102, and repeats the subsequent processes.

Further, when the control unit 141 detects the occurrence of the release event of the touch sensors 18 in the event-occurrence determination step S103, it determines whether the touch flag is set ON in step S110. When the control unit 141 determines that the touch flag is set OFF, it discards the release event in step S111, since the corresponding touch event does not occur. The case where the release is still detected even when the touch flag is set OFF includes the case where the touch sensors 18 are touched before initiation of the shift movement of the housings 12 and 13 or during the shift movement of the housings 12 and 13 (touch sensors 18 are in an off state), and then the touch sensors 18 are released after the shift movement of the housings 12 and 13 is completed while the touches to the touch sensors 18 are maintained (touch sensors 18 are in an on state).

When the control unit 141 determines that the touch flag is set ON, it sets the touch flag OFF in step S112. In step 113, the control unit 141 executes a predetermined process in accordance with the detection of the occurrence of the release event of the touch sensors 18. That is, the control unit 141 executes a predetermined process in response to the input of the instruction accepted by the touch sensors 18.

Incidentally, as described above, the control unit 141 is configured to execute the predetermined processes allocated to the touch sensors 18 upon detection of the release corresponding to the detected touch. The touch sensors 18 may accept different kinds of input operations depending on how long the touch sensors 18 are touched (duration of touch). The touch sensors 18 are not so limited to the above described operations, but the touch sensors 18 may also execute the predetermined processes upon detection of a touch. The control unit 141 returns to the input-process completion-determination step S102 and then repeats the subsequent processes.

In the input process at a time of performing the shift movement of the housings, the touch sensors 18 are kept turned off from the time when the shift movement of the housings 12 and 13 is initiated to the time when it is completed. With this arrangement, the touch and release events of the touch sensors 18 do not occur from the time when the shift movement of the housings 12 and 13 is initiated to the time when it is completed, and thus it is possible to suitably prevent the false triggering of touch sensors 18 accompanying the shift movement of the housings 12 and 13.

Further, in the case where the events occur in an order of: (1) touch event of the touch sensors 18; (2) shift-movement initiation event of the housings 12 and 13; (3) shift-movement completion event of the housings 12 and 13; and (4) release event of the touch sensors 18, the touch flag is set OFF in the flag OFF step S106 after the occurrence of (2) shift-movement initiation event of the housings 12 and 13. Thus, even when unintentional touches to the touch sensors 18 occur before the Initiation of the shift movement of the housings 12 and 13, it is determined that the touch flag is set OFF in the flag ON determination step S110 after the occurrence of (4) release event of the touch sensors 18, and therefore the detection of the release is discarded, thereby preventing the occurrence of the false triggering of the touch sensors.

Further, since the touch sensors 18 are kept turned off during the shift movement of the housings 12 and 13, it is possible to achieve the power saving.

Next, another input process at a time of performing the shift movement of the housings, executed by a cellular phone 100 according to the present embodiment will be described.

In another input process at a time of performing the shift movement of the housings as will be described below, in the case where a touch or release event of the touch sensors 18 occurs from the time when the cellular phone 100 detects the initiation of the shift movement of the housings 12 and 13 to the time when the cellular phone 100 detects the completion of the shift movements the cellular phone 100 negates the instruction of which input is accepted by the touch sensors 18 by discarding the occurrence of the event. With this arrangement, the cellular phone 100 may prevent the occurrence of the false triggering of the touch sensors 18 due to unintentional touches to the touch sensors 18. Details of another input process at a time of performing the shift movement of the housings will be described below.

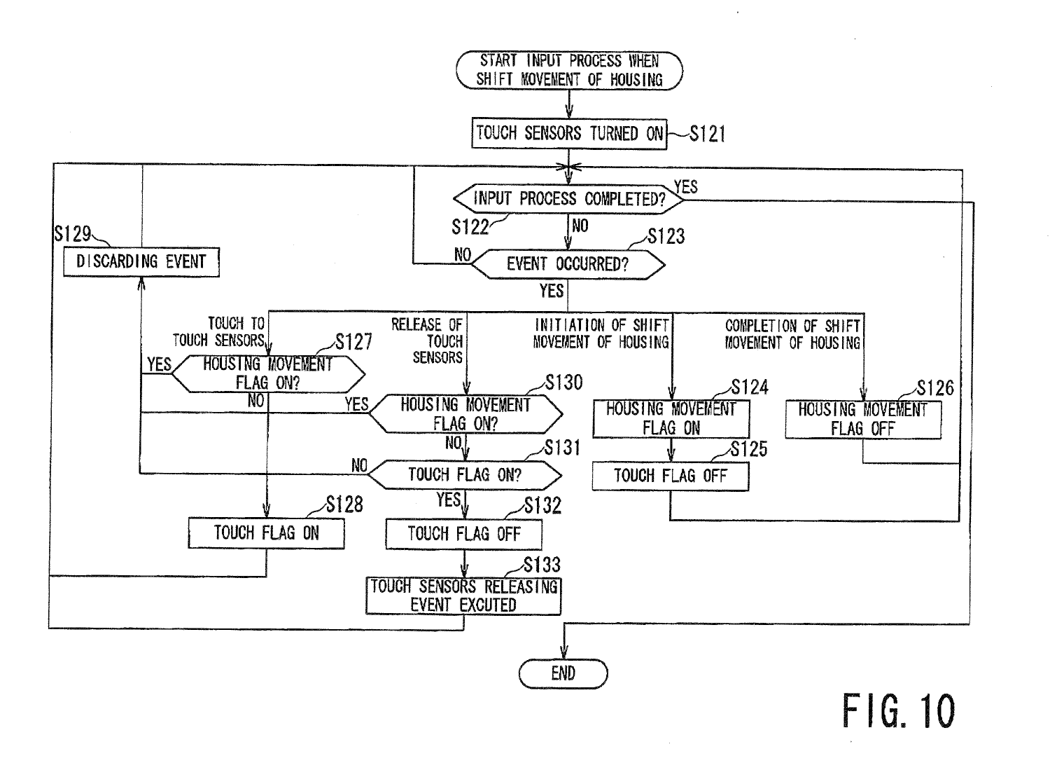

FIG. 10 shows a flowchart explaining the another input process at a time of performing the shift movement of the housing, executed by the control unit 141 of the cellular phone 100 in accordance with the present embodiment. The another input process at a time of the shift movement is initiated after the cellular phone 100 accepts an instruction of turning on the power source by a predetermined input operation, or a time when the operation lock of the first operation section 115 or the second operation section 21 is released, whereby the execution of the input process is initiated.

The processes in a touch sensors turned-on step S121 to an event-occurrence determination step S123 are generally similar to those of the touch sensors turned-on step S101 to the event-occurrence determination step S103 in the input process at the time of the shift movement of the housing in FIG. 9, and therefore the explanation thereof is omitted herein.

When the control unit 141 detects the occurrence of the initiation event of the shift movement of the housings 12 and 13 in the event-occurrence determination step S123, it sets the housing movement flag ON in step S124. Further, in step S125, the control unit 141 sets the touch flag OFF. The control unit 141 sets this touch flag OFF in accordance with the initiation of the shift movement of the housings 12 and 13, thereby discarding the touch event of the touch sensors 18 that has already occurred and been detected. Incidentally, when the touch flag is set OFF, the control unit 141 maintains the off state as it is in step S125. The control unit 141 returns to the input-process completion-determination step S122, and repeats the subsequent processes.

Next, when the control unit 141 detects the completion event of the shift movement of the housings 12 and 13 in the event-occurrence determination step S123, it sets the housing movement flag OFF in step S126. The control unit 141 then returns to the input-process completion-determination step S122 and repeats the subsequent processes.

On the other hand, when the control unit 141 detects a touch to the touch sensors 18 in the event-occurrence determination step S123, it determines whether the housing movement flag is set ON in step S127. When the control unit 141 determines that the housing movement flag is set OFF, it sets the touch flag ON in step S128. The control unit 141 then returns to the input-process completion-determination step S122 and repeats the subsequent processes.

On the other hand, when the control unit 141 determines that the housing moving flag is set ON, it discards the touch event in step S129 because the touches to the touch sensors 18 occur during the shift movement of the housings 12 and 13, and therefore the touch event occurred may be recognized as unintentional touches.

Further, when the control unit 141 detects the occurrence of the release event of the touch sensors 18 in the event-occurrence determination step S123, it determines whether the housing movement flag is set ON in step S130. When the control unit 141 determines that the shift movement flag is set ON, it discards the release event in step S129 because the release of the touch sensors 18 occurs during the shift movement of the housings 12 and 13, and therefore the release may be recognized as the one corresponding to unintentional touches.

On the other hand, when the control unit 141 determines that the housing movement flag is set OFF, it determines whether the touch flag is set ON in step S131. When the control unit 141 determines that the touch flag is set OFF, it discards the release event in step S129, because the corresponding touch event does not occur.

The case where the release is still detected even when the touch flag is set OFF includes the case where the touch sensors 18 are touched before the initiation of the shift movement of the housings 12 and 13 or during the shift movement of the housings 12 and 13 while the touches to the touch sensors 18 are maintained (touch flag is set OFF), and then the touch sensors 18 are released after the shift movement of the housing 12 and 13 has been completed.

When the control unit 141 determines that the touch flag is set ON in step S131, it sets the touch flag OFF in step S132. Further, in step S133, the control unit 141 executes the predetermined process in accordance with the detection of the release of the touch sensors 18 That is, the control unit 141 executes the predetermined process on the basis of the input of the instruction accepted by the touch sensors 18. The control unit 141 then returns to the input-process completion-determination step S122 and repeats the subsequent processes.

In the another input process at the time of performing the shift movement of the housing, the touch and release events of the touch sensors 18 occurred during the time from the initiation to the completion of the shift movement of the housings 12 and 13, are discarded. Accordingly, the predetermined process in accordance with the detection of the release of the touch sensors 18 is not executed, whereby it is possible to suitably prevent the occurrence of the false triggering of the touch sensors accompanying the shift movement of the housings 12 and 13.

Further, in the cases where the events occur in an order of (1) touch event of the touch sensors 18, (2) shift movement initiation event of the housings 12 and 13; (3) release event of the touch sensors 18; and (4) shift movement completion event of the housings 12 and 13, and an order of: (1) touch event of the touch sensors 18; (2) shift movement initiation event of the housings 12 and 13; (3) shift movement completion event of the housings 12 and 13; and (4) release event of the touch sensors 18, the control unit 141 sets the touch flag OFF in a flag OFF step S125 after the occurrence of (2) shift movement initiation event of the housings 12 and 13. That is, the control unit 141 discards the detection of the touch event upon the initiation of the shift movement of the housings 12 and 13. Thus, even when unintentional touches to the touch sensors 18 occur before the shift movement of the housing 12 and 13, it is determined that the touch flag is set OFF in the flag ON determination step S131 after the occurrence of (4) release event of the touch sensors 18, and the detection of the release is discarded, which prevents the occurrence of the false triggering of the touch sensors.

According to the cellular phone 100, the touch sensors 18 are kept in a power-off state or the input of the instruction accompanying the touch or release event of the touch sensors 18 that is detected is negated from the time when the cellular phone 100 detects the initiation of the shift movement of the housings 12 and 13 to the time when the cellular phone 100 detects the completion of the shift movement of the housings 12 and 13, whereby the false triggering of the touch sensors 18 caused by unintentional touches to the touch sensors 18 may be suitably prevented.

Incidentally, in the cellular phone 100 according to the present embodiment, an example in which a slide-type housing is adopted as a housing capable of the shift movement between the first state and the second state, has been described. However, the cellular phones that include the other housings which may be configured to have different opening/closing structures may also be applied to the present invention. Such housings applicable to the present invention include: a so-called folding-type in which upper housing and lower housing are hinged together; a swivel-type in which housings are rotatable about a rotation axis perpendicular to a rotation axis of a hinge; and a reversible-type in which housings are capable of 360-degree rotation about a rotation axis of a hinge.

Additionally, the layout of the touch-type input unit such as a touch sensors 18 is not limited to the layout shown in FIG. 6, but the touch sensors 18 may be disposed within a movable range in which the finger of the user, which performs the shift movement of the housings, may come into contact with the touch sensors. Further, the layout of the touch sensors 18 is not limited to the main surface of the upper housing 13, but the touch sensors 18 may be disposed on the lower housing 12, or the each side surface of the housings 12 and 13 Further, although it has been described that the magnetic sensors 124 are adopted as a detecting unit for detecting the initiation and the completion of the shift movement of the housings, the magnetic sensors may be replaced with other unit or like such as optical sensors.

The present invention is applicable to a PDA, a personal computer, a portable game machine, a portable music player, a portable video player, and other such portable terminal in addition to the cell phone.

A series of processing described in each embodiment of the present invention can be executed using hardware as well as software.

Further, although each embodiment describes an example of the processes executed on the time series in the order of description, the processes include processes executed in parallel or separately, not executed on the time series.

What is claimed is:

1. A mobile terminal comprising:
a housing;
a touch-type input unit configured to accept an input of a first instruction by detecting a touch to a touch face formed on a surface of the housing;
a movable unit;
a detecting unit configured to detect an operation to the movable unit; and
a control unit configured to negate the first instruction during detecting the operation by the detecting unit even if the touch-type input unit accepts the input.

2. The mobile terminal according to claim 1, wherein the movable unit is a movable-type input unit configured to accept an input of a second instruction on the basis of the operation, the movable-type input unit being provided on the surface of the housing.

3. The mobile terminal according to claim 2, wherein when the initiation of the operation of the movable-type input unit is detected, the control unit negates the first instruction by causing the touch-type input unit to be in an off state in which no input is accepted.

4. The mobile terminal according to claim 3, wherein when the completion of the operation of the movable-type input unit is detected, the control unit causes the touch-type input unit to be in an on state in which the input is accepted.

5. The mobile terminal according to claim 2, wherein when the initiation of the operation of the movable-type input unit is detected, the control unit negates the first instruction by discarding the detection of the input accepted by the touch-type input unit.

6. The mobile terminal according to claim 5, wherein:
the touch-type input unit accepts the first instruction by a detection of an initiation of the touch and a detection of a completion of the touch to the touch face; and
when the initiation of the touch to the touch-type input unit is detected after the initiation of the operation of the movable type-input unit is detected, the control unit negates the first instruction by discarding the detection of the initiation of the touch.

7. The mobile terminal according to claim 5, wherein:
the touch-type input unit accepts the first instruction by a detection of an initiation of the touch and a detection of a completion of the touch to the touch face; and
when the completion of the touch to the touch-type input unit is detected after the initiation of the operation of the movable-type input unit is detected, the control unit negates the first input unit by discarding the detection of the completion of the touch.

8. The mobile terminal according to claim 2, wherein the movable-type input unit is a rotative-type input unit or a slide-type input unit.

9. The mobile terminal according to claim 1, wherein
the housing is the movable unit performing a shift movement between a first state and a second state different from the first state;
the detecting unit detects the shift movement between the first state and the second state.

10. The mobile terminal according to claim 9, wherein when the initiation of the shift movement of the housing is detected, the control unit negates the first instruction by causing the touch-type input unit to be in an off state in which no input is accepted.

11. The mobile terminal according to claim 10, wherein when the completion of the shift movement of the housing is detected, the control unit causing the touch-type input unit to be in an on state in which the input is accepted.

12. The mobile terminal according to claim 9, wherein when the completion of the shift movement of the housing is detected, the control unit negates the first instruction by discarding the detection of the input accepted by the touch-type input unit.

13. The mobile terminal according to claim 12, wherein:
the touch-type input unit accepts the first instruction by a detection of an initiation of the touch and a detection of a completion of the touch to the touch face; and
when the initiation of the touch to the touch-type input unit is detected after the initiation of the shift movement of the housing is detected, the control unit negates the first input by discarding the detection of the initiation of the touch.

14. The mobile terminal according to claim 12, wherein:
the touch-type input unit accepts the first instruction by a detection of an initiation of the touch and a detection of a completion of the touch to the touch face; and
when the completion of the touch to the touch-type input unit is detected after the initiation of the shift movement of the housing is detected, the control unit negates the detection of the completion of the touch.

15. The mobile terminal according to claim 9, wherein the housing is a slide-type housing, a folding-type housing, a swivel-type housing or reversible-type housing.

16. A mobile terminal comprising:
a housing;
a touch-type input unit configured to accept an input of a first instruction by detecting a touch to a touch face provided on a surface of the housing;
a movable-type input unit configured to accept an input of a second instruction, the movable-type input unit being provided on the surface of the housing; and
a control unit configured to negate the first instruction during detecting the input of the movable-type input unit even if the touch-type input unit accepts the input.

17. A mobile terminal comprising:
a housing configured to perform a shift movement between a first state and a second state different from the first state;
a touch-type input unit configured to accept an input of an instruction by detecting a touch to a touch face provided on a surface of the housing;
a detecting unit configured to detect the shift movement of the housing between the first state and the second state; and
a control unit configured to negate the first instruction during detecting the shift movement of the housing even if the touch-type input unit accepts the input.
